(19) United States
(12) Patent Application Publication
(10) Pub. No.: US 2024/0324557 A1
(43) Pub. Date: Oct. 3, 2024

(54) METHOD OF COMMUNICATION WITH A PET

(71) Applicant: Audrey Havican, Eagle Grove, IA (US)

(72) Inventor: Audrey Havican, Eagle Grove, IA (US)

(21) Appl. No.: 18/128,432

(22) Filed: Mar. 30, 2023

(51) Int. Cl. A01K 15/02

(52) U.S. Cl. CPC A01K 15/021

(57) ABSTRACT

A method of communication between a user and a pet includes operating a user interface to turn on a pet interface, which is wirelessly coupled to the user interface. Audiovisual streams are transmitted between the user interface and the pet interface such that the user and the pet may communicate with each other through the user and pet interfaces. An access code is required for the user interface to be operated to turn on the pet interface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to communication systems and more particularly pertains to a new communication system for facilitating communication between a user and a pet which are remotely located from each other.

### (2) Description of Related Art Including Information Disclosed Under 37 CFR 1.97 and 1.98

The prior art discloses communication systems which facilitate communication between a user and a pet which are remotely located from each other. However, the prior art does not describe such a system or method of communication in which a user interface is operated to turn on a pet interface that is wirelessly coupled to the user interface and in which an access code must be entered into the user interface to turn on the pet interface.

### BRIEF SUMMARY OF THE INVENTION

An embodiment of the disclosure meets the needs presented above by generally comprising a method of communication between a user and a pet, the method comprising positioning a pet interface proximate to the pet and positioning a user interface proximate to the user and remote from the pet interface and the pet. The user interface is operated to turn on the pet interface, which is wirelessly coupled to the user interface. The user interface records a user audio stream and a user video stream and transmits each to the pet interface, which audibly plays the user audio stream and displays the user video stream. The pet interface records a pet audio stream and a pet video stream and transmits each to the user interface, which audibly plays the pet audio stream and displays the pet video stream. The step of operating the user interface to turn on the pet interface comprises entering an access code into the user interface, wherein the pet interface is configured to turn on only if the access code is entered into the user interface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a user interface and a pet interface used for a method of communication between a user and a pet according to an embodiment of the disclosure.

FIG. 2 is a front view of the pet interface used in an embodiment of the disclosure.

FIG. 3 is a back view of the pet interface used in an embodiment of the disclosure.

FIG. 4 is a front view of the user interface used in an embodiment of the disclosure.

FIG. 5 is a block diagram of the user interface and the pet interface used in an embodiment of the disclosure.

FIG. 6 is an in-use view of the user interface and the pet interface used in an embodiment of the disclosure.

### DETAILED DESCRIPTION OF THE INVENTION

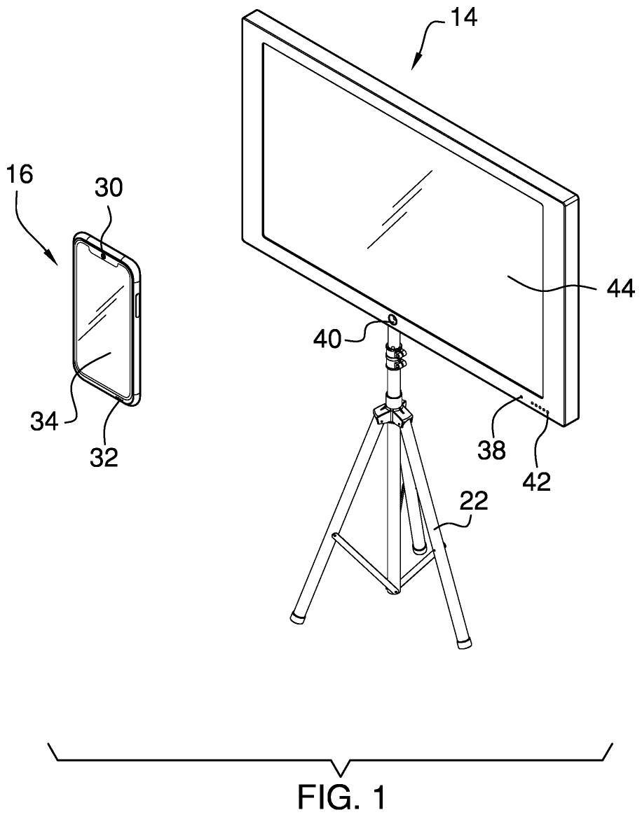

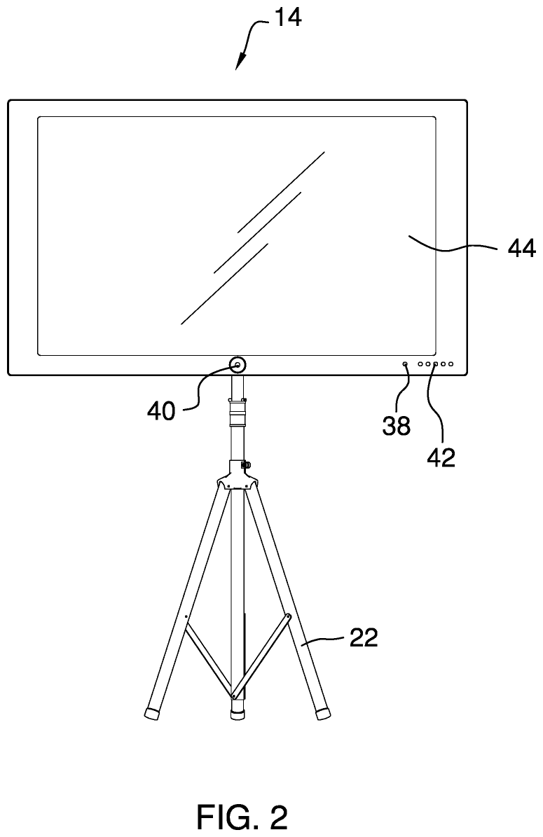

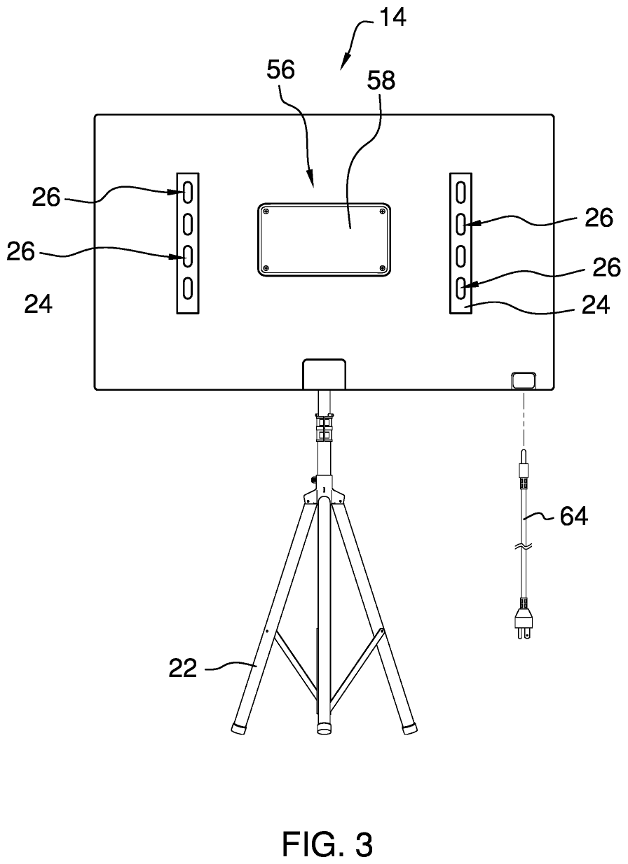

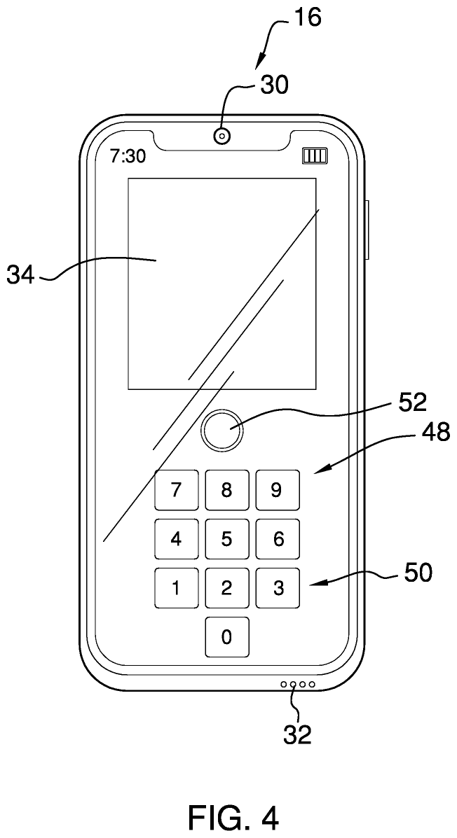

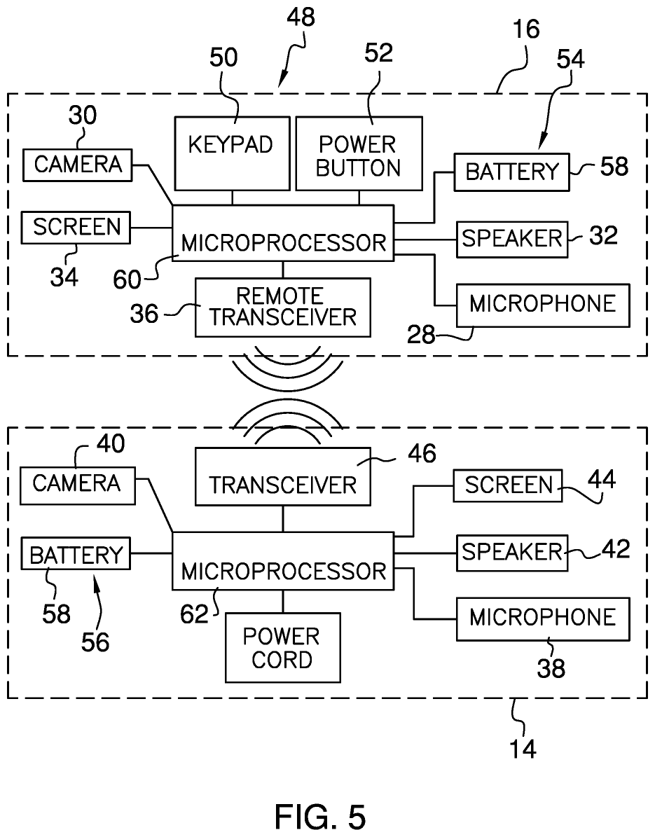

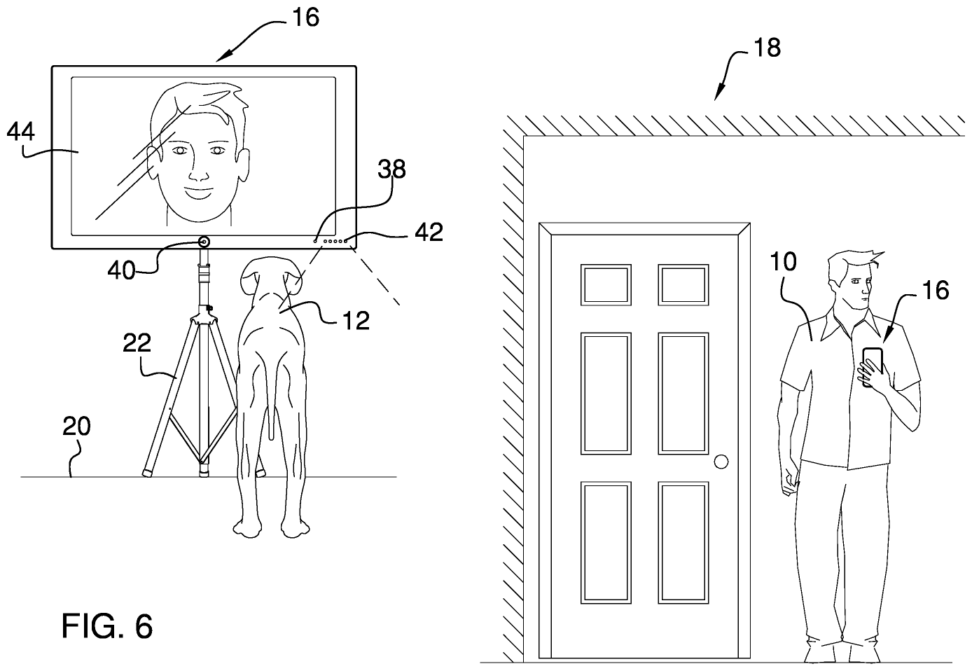

With reference now to the drawings, and in particular to FIGS. 1 through 6 thereof, a new communication system embodying the principles and concepts of an embodiment of the disclosure and generally designated by the reference numeral 10 will be described.

As best illustrated in FIGS. 1 through 6, the method of communication between a user 10 and a pet 12 generally comprises positioning a pet interface 14 proximate to the pet 12 and positioning a user interface 16 proximate to the user 10 and remote from the pet interface 14 and the pet 12. The user interface 16 is operated to turn on the pet interface 14 which is wirelessly coupled to the user interface 16. The pet interface 14 may be wirelessly coupled to the user interface 16 via a communications network. The pet interface 14 and the pet 12 are positioned in a dwelling 18, and the user interface 16 and the user 10 are positioned out of the dwelling 18. The communications network may be the Internet, a cellular network, an intranet, or the like. The user interface 16 records a user audio stream and a user video stream and transmits each to the pet interface 14, which audibly plays the user audio stream and displays the user video stream. The pet interface 14 records a pet audio stream and a pet video stream and transmits each to the user interface 16, which audibly plays the pet audio stream and the pet video stream. The pet interface 14 is configured to turn on only if an access code is entered into the user interface 16. The access code may take the form of an alphanumeric password, a sequence of key presses, a graphical symbol, or the like.

The pet interface 14 may be positioned on a support surface 20 in the dwelling 18 or mounted to a wall of the dwelling 18. The pet interface 14 includes a tripod 22 for supporting the pet interface 14 on the support surface 20 and at least one bracket 24 for mounting the pet interface 14 on the wall. The at least one bracket 24 has at least one hole 26 extending therein for receiving a protrusion on the wall to facilitate mounting the bracket 24 on the wall.

The user interface 16 includes a first microphone 28 and a first camera 30 to record the user audio stream and the user video stream respectively. The user interface 16 also includes a first sound emitter 32 and a first display screen 34 for playing the pet audio stream and displaying the pet video stream respectively. The pet interface 14 includes a second microphone 38 and a second camera 40 to record the pet audio stream and the pet video stream respectively. The pet interface 14 also includes a second sound emitter 42 and a second display screen 44 for playing the user audio stream and displaying the user video stream respectively. The pet interface 14 and the user interface 16 have a first transceiver 36 and a second transceiver 46 respectively such that the pet and user interfaces 14, 16 are able to wirelessly communicate to each other.

The user interface 16 includes an input 48 for controlling the user interface 16 and the pet interface 14, including turning the pet interface 14 on, and entering the access code. The input 48 comprises a keypad 50 configured for receiving the access code and a power button 52 configured for turning the pet interface 14 on. However, the input 48 may comprise a touchscreen which may be integrally formed with the second display screen 44, knobs, buttons, or the like. The user interface 16 may be a smartphone, tablet, personal computer, or the like.

The pet interface 14 and the user interface 16 comprise a first power supply 54 and a second power supply 56 respectively, each of which comprises a battery 58. A first control circuit 60 is electrically coupled to each of the first microphone 28, the first camera 30, the first sound emitter 32, the first display screen 34, the first transceiver 36, and the first power supply 54. A second control circuit 62 is electrically coupled to each of the second microphone 38, the second camera 40, the second sound emitter 42, the second display screen 44, the second transceiver 46, the input 48, and the second power supply 56. The pet interface 14 also includes a power cord 64 which is removably electrically coupled to the second control circuit 62 and electrically couplable to an external power source.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of communication between a user and a pet, the method comprising:
positioning a pet interface proximate to the pet;
positioning a user interface proximate to the user and remote from the pet interface and the pet;
operating the user interface to turn on the pet interface, wherein the pet interface is wirelessly coupled to the user interface;
recording, by the user interface, a user audio stream and a user video stream;
transmitting, by the user interface, the user audio stream and the user video stream to the pet interface;
audibly playing, by the pet interface, the user audio stream;
displaying, by the pet interface, the user video stream;
recording, by the pet interface, a pet audio stream and a pet video stream;
transmitting, by the pet interface, the pet audio stream and the pet video stream to the user interface;
audibly playing, by the user interface, the pet audio stream;
displaying, by the user interface, the pet video stream; and
wherein the step of operating the user interface to turn on the pet interface comprises entering an access code into the user interface, wherein the pet interface is configured to turn on only if the access code is entered into the user interface.

2. The method of claim 1, further comprising positioning the pet interface and the pet in a dwelling.

3. The method of claim 2, further comprising positioning the user interface and the user out of the dwelling.

4. The method of claim 2, further comprising positioning the pet interface on a support surface.

5. The method of claim 4, wherein the pet interface includes a tripod for supporting the pet interface on the support surface.

6. The method of claim 2, further comprising mounting the pet interface on a wall of the dwelling.

7. The method of claim 6, wherein the pet interface includes at least one bracket having at least one hole extending therein such that a protrusion on the wall is receivable into the at least one hole to mount the bracket to the wall.
